(19) United States
(12) Patent Application Publication
(10) Pub. No.: US 2012/0082597 A1
(43) Pub. Date: Apr. 5, 2012

(54) Analyte Test Strip Dispensers and Elastomeric Caps for Sealing the Dispensers

(75) Inventors: Ken Doniger, Menlo Park, CA (US); Craig W. Sharp, San Francisco, CA (US); Benjamin M. Rush, Oakland, CA (US)

(73) Assignee: Abbott Diabetes Care Inc.

(21) Appl. No.: 12/895,484

(22) Filed: Sep. 30, 2010

(51) Int. Cl. G01N 31/22

(52) U.S. Cl. 422/401

(57) ABSTRACT

In some aspects, analyte test strip dispensers are provided. In some aspects, the analyte test strip dispensers store a plurality of analyte test strips and dispense one or more analyte test strips when needed. The analyte test strips may be stacked with an analyte test strip at one of the stack engaged with a dispensing element. The dispensing element may be slid relative to the dispenser to displace the analyte test strip out of the dispenser. In some aspects, an elastomeric cap having strong barrier properties for water vapor and moisture is provided. The elastomeric cap may be undersized in relation to the dispenser and stretched to couple to the dispenser, thus providing a pressure-fit seal along with strong barrier properties to water vapor and moisture.

### BACKGROUND

Analyte test strips have been used with analyte test meters to provide measurements of analyte levels of a sample. One common application is the determination of blood glucose levels for diabetics. Typically, a diabetic obtains a test strip, inserts it into a glucose meter, pricks his finger using a lancet, and then applies a blood sample to the test strip so the meter may provide a blood glucose measurement.

A number of test strips are usually stored together in container, such as a vial with a cap. When a test strip is needed, the patient opens the container and inserts a finger or two into the container to grab the test strip. Typically, the vial is usually small and includes a large number of small test strips. Obtaining a single test strip from the vial can pose a small challenge for some patients. Often, the patient finds it easier to pull out a group of test strips and then take one test strip from the group, after which the patient returns the remainder of the group to the vial. Alternatively, the patient may tip the vial to slide test strips partially or completely out of the vial to obtain a single test strip. Such techniques may unnecessarily expose other test strips to potential contaminants outside the vial, and may also lead to the patient spilling one or more test strips. Furthermore, vials are typically used with sealing caps to protect against moisture and humidity. However, sealing techniques against moisture and humidity for more complex dispensers prove challenging and difficult to achieve, and further are avoided due to complex and costly designs.

### SUMMARY

In some aspects, analyte test strip dispensers are provided. In some aspects, the analyte test strip dispensers store a plurality of analyte test strips and dispense one or more analyte test strips when needed. The analyte test strips may be stacked with an analyte test strip at one of the stack engaged with a dispensing element. The dispensing element may be slid relative to the dispenser to displace the analyte test strip out of the dispenser. In some aspects, an elastomeric cap having strong barrier properties for water vapor and moisture is provided. The elastomeric cap may be slightly undersized in relation to the dispenser and stretched to couple to the dispenser, thus providing a pressure-fit seal along with strong barrier properties to water vapor and moisture.

These and other objects, advantages, and features of the invention will become apparent to those persons skilled in the art upon reading the details of the invention as more fully described below.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIG. 1 illustrates an exploded side view of an analyte test strip dispenser, according to certain embodiments;

FIGS. 2A and 2B illustrate perspective views of the top and bottom, respectively, of an example analyte test strip that may be used in an analyte test strip dispenser, according to certain embodiments;

FIGS. 3A and 3B illustrate perspective views of the strip carrier and stack of analyte test strips before and after the stack is disposed in the strip carrier, according to certain embodiments;

FIG. 4 illustrates a perspective view of the strip carrier of FIGS. 3A and 3B without a biasing element coupled thereto, according to certain embodiments;

FIGS. 5A and 5B illustrate perspective views of a dispensing element, according to certain embodiments;

FIG. 6 illustrates a perspective view of a housing, according to certain embodiments;

FIG. 7 illustrates a perspective view of a cap for a dispenser, according to certain embodiments;

FIGS. 8A and 8B illustrate perspective views of a cap uncoupled and coupled, respectively, with a dispenser, according to certain embodiments;

FIGS. 9A, 9B, and 9C illustrate perspective views of a dispenser at various stages when an analyte test strip is being dispensed, according to certain embodiments; and

FIG. 10 illustrates cross-sectional side view of an analyte test strip dispenser, according to certain embodiments.

### DETAILED DESCRIPTION OF THE INVENTION

Before the present inventions are described, it is to be understood that this invention is not limited to particular aspects described, as such may, of course, vary. It is also to be understood that the terminology used herein is for the purpose of describing particular aspects only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supercedes any disclosure of an incorporated publication to the extent there is a contradiction.

It must be noted that as used herein and in the appended claims, the singular forms “a”, “an”, and “the” include plural references unless the context clearly dictates otherwise. Thus, for example, reference to “a biasing element” includes a plurality of such biasing element and reference to “the biasing element” includes reference to one or more biasing elements and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

As summarized above, analyte test strip dispensers are provided in the present disclosure. In some aspects, the analyte test strip dispensers store a plurality of analyte test strips and dispense one or more analyte test strips when needed. The analyte test strips may be stacked with an analyte test strip at one of the stack engaged with a dispensing element. The dispensing element may be slid relative to the dispenser to displace the analyte test strip out of the dispenser. When the analyte test strip is completely removed from the dispenser, the dispenser is configured such that the dispensing element engage the next analyte test strip that was adjacent to the analyte test strip that was dispensed, so that it may be subsequently dispensed by the dispensing element.

In some aspects of the present disclosure, analyte test strip dispensers are provided. As will be fully explained below, analyte test strip dispensers, and equivalents thereof, serve as means for storing a plurality of analyte test strips and dispensing analyte test strips for removal from the dispenser. In some aspects of the present disclosure, the plurality of analyte test strips is stacked within the dispenser. The analyte test strips are stacked in a longitudinal direction and comprise a last analyte test strip at one end of the stack and a next analyte test strip adjacent the last analyte test strip. The term “last analyte test strip” is used herein to refer to an analyte test strip that is at one end of the stack and that will be dispensed next by the dispenser. The term “next analyte test strip” is used herein to refer to an analyte test strip that is adjacent to the last analyte test strip and that will be subsequently positioned at the end of the stack after the last analyte test strip is dispensed from the dispenser.

In certain embodiments, an analyte test strip dispenser includes a housing, strip carrier, stack of analyte test strips, a dispensing element, and a biasing element. The strip carrier, and equivalents thereof, serve as means for holding the stack of analyte test strips. For example, the strip carrier may be disposed within the housing and include a stack of analyte test strips removably disposed in the strip carrier. In alternative embodiments, a dispenser may not include a strip dispenser, but instead hold the stack of analyte test strips within the housing—e.g., within a sleeve and/or within alignment walls in the housing.

The strip carrier may be made from any type of material that is sturdy enough to hold the stack of analyte test strips. For example, the strip carrier may be made from various metals and metal alloys (e.g., aluminum, aluminum alloys, etc.), polymers such as plastics, or any other suitable material. In some instances, a light weight material is used to account for weight consideration of the hand-held dispenser.

The dispensing element, and equivalents thereof, serve as means for engaging an analyte test strip and displacing the analyte test strip out the dispenser. In some instances, the dispensing element may be configured to dispense the analyte test strip partially outside the dispenser such that a user may grab the analyte test strip and completely remove it from the dispenser. In other instances, the dispensing element may be configured to dispense the analyte test strip completely outside the dispenser, ejecting it from the dispenser.

In certain embodiments, the dispensing element is configured to displace the last analyte test strip partially outside the dispenser when slid in a first direction and to maintain the last analyte test strip in the displaced position for removal when slid back in the opposite direction. For example, the dispensing element may be slidably coupled to the strip carrier and adjacent to a last analyte test strip at one end of the stack. The dispensing element may be slid in a first direction to displace the analyte test strip out the housing of the dispenser, and then slid back to its original starting position without displacing the last analyte test strip back to its original starting position on the stack. For example, the dispensing element may maintain the last analyte test strip at its displaced position (e.g., partially outside the housing of the dispenser) with a first portion of the analyte test strip outside the housing and a second portion of the analyte test strip within the housing and between the dispensing element and a next analyte test strip.

A biasing element, and equivalents thereof, serve as a means for applying a biasing force to the stack of analyte test strips in a direction towards the dispensing element. In this way, the stack of analyte test strips are biased toward the dispensing element and enable the last analyte test strip to be engage and dispensed by the dispensing element. Furthermore, when an analyte test strip is removed, the stack of analyte test strips are biased toward the dispensing element and enable the next analyte test strip to be engaged and dispensed by the dispensing element.

Any variety of biasing elements may be used, and in certain embodiments, the biasing element is a constant spring force which applies approximately a constant force to the stack of analyte test strips irrespective of the number of analyte test strips remaining in the stack. In some instances, a block of desiccant may be coupled to the stack of analyte test strips and act as a base for the stack of analyte test strips. In such cases, the biasing element may be coupled to the block of desiccant and apply a biasing force to the stack of analyte test strips via the block of desiccant. The block of desiccant, and equivalents thereof, serve as a means to absorb water vapor and moisture within the dispenser.

In certain embodiments, the dispensing element may include an abutment surface that abuts the last analyte test strip and an engagement element that engages the last analyte test strip and displaces it in a first direction when the dispensing element is slid in the first direction. Then when the first analyte test strip is removed from the analyte test strip dispenser, the engagement element engages the next analyte test strip. For example, the engagement element may comprise a protrusion extending from the abutment surface and adjacent to a side edge of the last analyte test strip. The protrusion may then push the last analyte test strip from the first position to the second position when the dispensing element is slid in the first direction. When the last analyte test strip is removed from the dispenser, the biasing force may displace the next analyte test strip towards the dispensing element such that the abutment surface is abutting the next analyte test strip with the protrusion extending adjacent to a side edge of the second analyte test strip.

The engagement element may vary in shape and size, but should be smaller than the height of the side edge of an analyte test strip to avoid engaging the next analyte test strip at the same time. In alternative embodiments, the engagement element may be designed larger than the height of the side edge of an analyte test strip in order to dispense more than one analyte test strip at a time.

In certain embodiments, the dispensing element comprises recessed surfaces and slots for coupling with the strip carrier. The strip carrier may comprise coupling elements that extend along the recessed surfaces and fit within the slots. In this way, the coupling elements may slide along the recessed surfaces and within the slots when the dispensing element is slid in the first direction and back in the opposite direction.

It should be appreciated that any variety of coupling mechanisms may be used that enable the dispensing element to slide while being coupled to the strip carrier. The coupling elements may comprise, for example, arm extensions extending from the strip carrier having lips at its ends (e.g., formed by bends in the arms) that slide along the recessed surfaces with the lips sliding within the slots. When the ends of the recessed surfaces and/or slots are contacted by the arm extensions and lips, the dispensing element is prevented from sliding any further.

In certain embodiments, the dispensing element comprises a curved contour that aligns approximately flush with a curved contour of the housing. In some instances, the curved contours may be semi-circularly shaped or semi-elliptically shaped.

The housing, and structures equivalent thereto, serve as a means for housing the strip carrier and plurality of analyte test strips. In certain embodiments, the dispenser includes a housing having an open end at a distal end of the housing. The strip carrier, stack of analyte test strips, and dispensing element are disposed within the housing and oriented so that the dispensing element and last analyte test strip are near an open end of the housing. In this way, the last analyte test strip may be displaced out of the housing via the open end of the housing. The term “open end” and “open end of the housing” are used herein generally to refer to the portion of the housing that is open or that has an opening, and not necessarily limited to one end of the device. Furthermore, the “open end of the housing” may be referred to herein to generally include the dispensing element that is attached at the open end of the housing. Although the open end of the housing is shown in the embodiment at a distal end of the housing, it should be appreciated that in other embodiments, the open end of the housing may refer to a portion of the housing that has an opening and that may be capped by cap. The size of the portion of the cap that is capped by cap may vary but should be large enough to include the opening to provide a seal around the opening.

The housing may vary in size and shape but should generally be shaped and sized to house the strip carrier, stack of analyte tests strips, and dispensing element and yet be comfortably held and used by a user. The housing may be made out of any variety of materials that provide sufficient structural support to house and protect the analyte test strips. Example materials may include, metals, metal alloys, polymers such as plastics, etc.) In some instances, the housing may be made out of a material that acts as a strong barrier to water vapor and moisture—e.g., cycloolefin copolymer, etc.

It should be appreciated that in some instances, the housing may be comprised of more than one piece and/or may be comprised of more than one type of material. Further, it should be appreciated that the strip carrier, stack, and dispensing element may be disposed within the housing in any variety of manners—e.g., inserted into opening of the housing; the housing assembled around the strip carrier, etc.

The housing may be made from any variety of materials (e.g., hard molded plastic, elastomeric material, metal and/or metal alloys, etc.) that provide protection to the strip carrier, stack, and dispensing element from physical damage. The housing may also provide protection from contamination, such as dirt, oil, debris, water vapor and moisture, etc. In some instance, the housing is made from a material that acts as a strong barrier to water vapor and moisture—e.g., cycloolefin copolymer, etc.

In some aspects of the present disclosure, a cap is provided and removably couples to the housing and dispensing element to provide a sealed environment for the stack of analyte test strips when coupled. The cap may provide protection from dirt, oils, debris, water vapor and moisture, and/or other contaminants. The cap may be made out a variety of materials—e.g., metals, metal alloys, polymers (e.g., plastics), etc.).

In some aspects of the present disclosure, an elastomeric cap is provided that may be coupled with the dispensers of the present disclosure. In certain embodiments, the cap is made out of a thermoplastic elastomer, a thermoset material, EPDM, or any other elastomeric material having strong barrier properties for water vapor and moisture—e.g., cycloolef in copolymer, etc. In this way, the elastomeric cap may be used to seal the dispenser against the ingress of moisture and water vapor. The elastomeric cap may be undersized in relation to the dispenser and stretched to couple to the dispenser, thus providing a pressure-fit seal along with strong barrier properties to water vapor and moisture. For example, the interior cavity of the cap may be undersized with respect to the portion of the housing (and dispensing element) that fits within the cavity. The cap may be removed when an analyte test strip is needed, and then recoupled with the dispenser after a test strip is dispensed.

In some aspects, the cap is shaped and sized to correspond to the open end of the housing that fits within the cavity of the cap. For instance, the cavity may include an opening of cavity that is similarly shaped to the housing portion in which the opening is stretched over. For example, the opening may be rectangular and stretch over a rectangular shaped sidewalls of the housing. In some instances, the interior surface of the cavity may include a curved contour that is similarly shaped to the curved contour of the dispensing element and the curved contour of the housing 111 to provide a tight seal when stretched around the curved contours of the dispensing element and housing. It should be appreciated that the opening of the cavity of the cap, as well as the interior surface of the cavity of the cap, may be similarly shaped to its respective counterpart that it stretches over, and yet still be undersized from the respective counterpart.

In some instances, the cap comprises an interior surface of the cavity having a curved contour that approximates the shape of the curved contour of the dispensing element and the curved contour of the housing. In this way, a snug fit may be achieved. Furthermore, in some instances, the cap is elastomeric and stretched over the curved contour of the housing and the curved contour of the dispensing element when coupled. In this way, a pressure-fit seal is provided by the cap. In some instances, the curved contours are approximately semi-elliptically shaped. In other instances, the curved contours are approximately semi-circularly shaped. Moreover, the elastomeric cap may comprise elastomeric side arms. The elastomeric arms may, in some instances, removably couple the cap to the dispenser. In some instances, the elastomeric arms may also serve to seal the open end of the housing.

In certain embodiments, the cap may include mating elements that mate with retention elements on the housing of the dispenser to retain the cap on the dispenser—e.g., fasten, attach, or other suitable retaining mechanism. For example, the cap may include mating elements (e.g., indents or grooves) on side arms of the cap that mate with retention elements on the housing (e.g., fastening knobs, hooks, or other protruding elements) to fasten the cap to the housing.

The following detailed description of the figures refers to the accompanying drawings that illustrate exemplary embodiments of an analyte test strip dispenser. Other embodiments are possible. Modifications may be made to the embodiments described herein without departing from the spirit and scope of the present invention. Therefore, the following detailed description is not meant to be limiting.

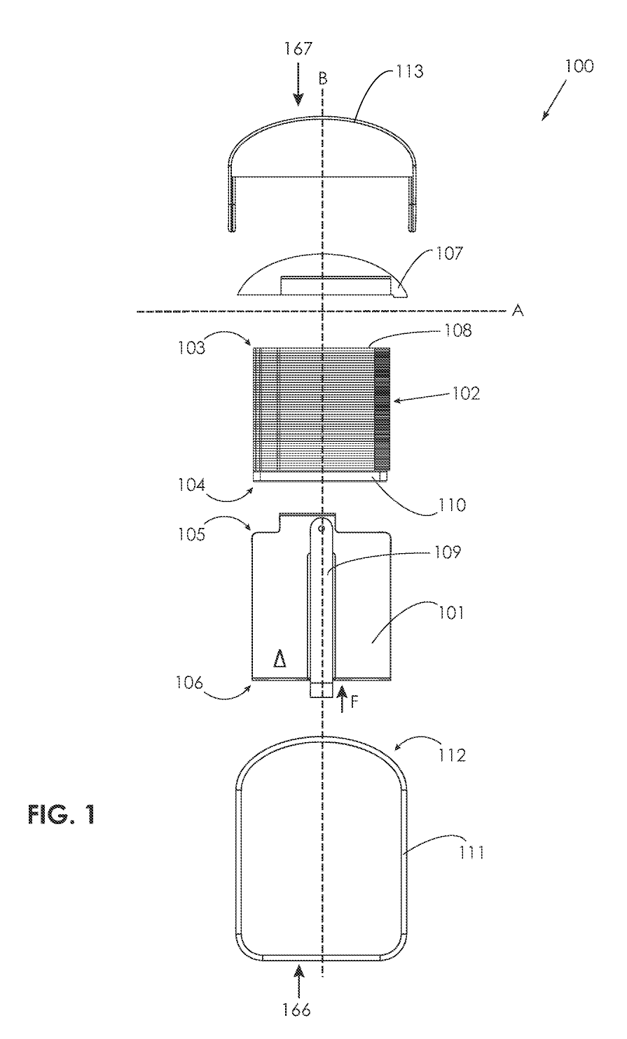

FIG. 1 illustrates an exploded side view of an analyte test strip dispenser, according to certain embodiments. Analyte test strip dispenser 100 is shown comprising a strip carrier 101 and a stack 102 of analyte test strips. The stack 102 of analyte test strips is disposed in the strip carrier 101. To facilitate explanation of the dispenser 100 and components thereof, a longitudinal axis B and latitudinal axis A are defined as shown in FIG. 1. The longitudinal axis runs from a proximal end 166 of the dispenser 100 to a distal end 167 of the dispenser 100, with the analyte test strips stacked longitudinally. Furthermore, each component in the dispenser may accordingly have a proximal end and distal end—e.g., as shown in FIG. 1, the stack 102 has a distal end 103 and a proximal end 104; the strip carrier 101 has a distal end 105 and a proximal end 106. Moreover, a latitudinal axis is shown in FIG. 1 to be perpendicular to the longitudinal axis.

The dispensing element 107 couples to the distal end 105 of the strip carrier 101 and engages a last analyte test strip 108 at the distal end 103 of the stack 102. A biasing element 109 couples to the strip carrier 101 and applies a biasing force F against the plurality of analyte test strips in a direction toward the dispensing element 107 and distal end 105 of the strip carrier 101. Biasing element 109 is shown as a constant force spring that applies a constant force against the proximal end 104 of the stack 102 irrespective of the number of analyte test strips remaining in the stack 102.

In the embodiment shown, the dispensing element 107 slidably couples to the distal end 105 of the stack carrier 101 and engages the last analyte test strip 108. When coupled to the stack carrier 101, the dispensing element 107 is adapted to slide relative to the strip carrier 101 along latitudinal axis A to displace the last analyte test strip 108 in the latitudinal direction. It should be appreciated that a variety of coupling mechanisms may be used that enable the dispensing element 107 to slide while being coupled to the strip carrier 101.

A block of desiccant 110 is shown in FIG. 1 at the proximal end 104 of the stack 102 and serves to absorb moisture and maintain a dry environment within the dispenser 100 for the analyte test strips. Furthermore, the block of desiccant 110 may also serve as a base for the stack 102 of analyte test strips. Moreover, the block of desiccant enables the biasing element 109 to apply the biasing force F to the stack 102 via the block of desiccant 110 without having to contact, and possibly damage, any analyte test strips within the stack 102.

Dispenser 100 is shown to include a housing 111 having an open end 112 at a distal end of the housing. The strip carrier 101, stack 102 of analyte test strips, and dispensing element 107 are disposed within the housing 111. The dispensing element 107, strip carrier 101, and stack 102 are oriented within the housing 111 with the dispensing element 107 near the open end 112 of the housing 111.

The housing 111 is sized and shape to house the strip carrier 101, stack 102 of analyte tests strips, and dispensing element 107. As stated before, the housing 111 may be made out of a variety of materials that provide sufficient structural support to protect the analyte test strips. Example materials may include, for example, metals, metal alloys, polymers (e.g., plastics), etc.) In some instances, the housing may be made out of a material that acts as a strong barrier to water vapor and moisture—e.g., cycloolefin copolymer, etc.

Dispenser 100 is also shown including a cap 113 that removably couples to the housing 111 to provide a sealed environment for the analyte test strips within the housing 111 when coupled. As stated before, cap 113 may be made out any variety of materials—e.g., metals, metal alloys, polymers (e.g., plastics), etc.). In certain embodiments, cap 113 is made out of an elastomeric polymer, or any other elastic material, such that the cap 113 may be undersized with respect to the open end 112 of the housing 111, so a tight seal will be formed when the cap 113 is stretched over the open end 112 of the housing 111. In some instances, the cap 113 is made out of a material that acts as a strong barrier to water vapor and moisture (e.g., cycloolefin copolymer, etc.).

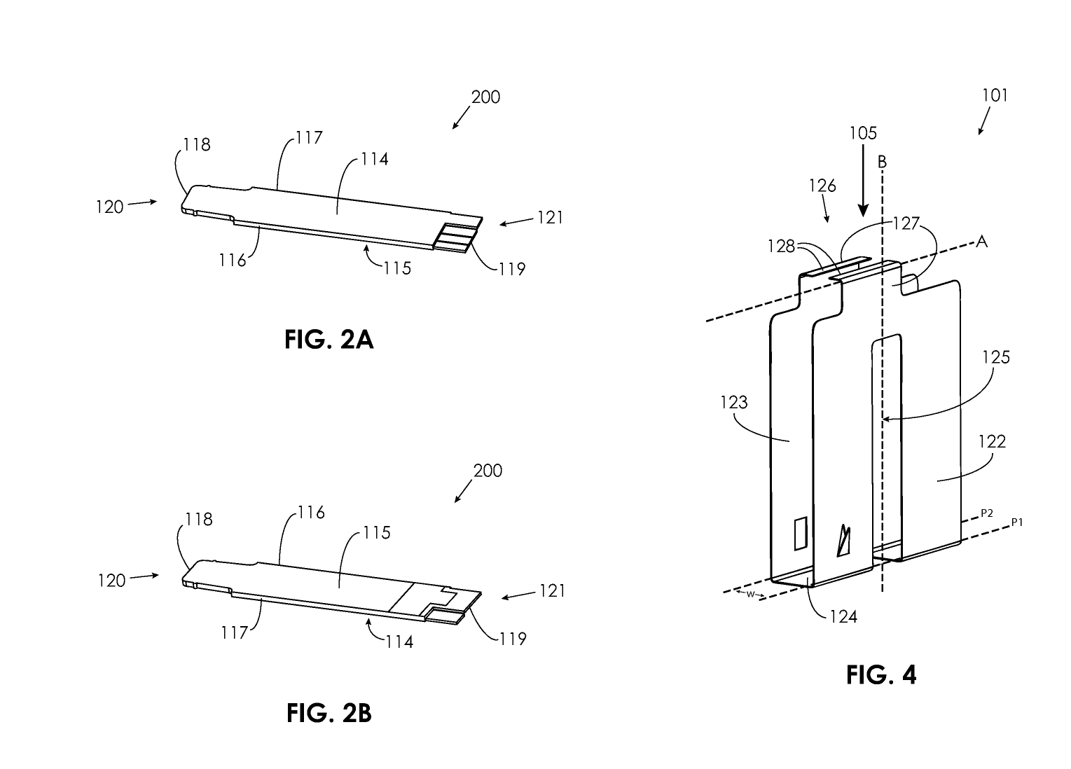

FIGS. 2A and 2B illustrate perspective views of the top and bottom, respectively, of an example analyte test strip that may be used in an analyte test strip dispenser, according to certain embodiments. The analyte test strip 200 shown in FIGS. 2A & 2B is generally rectangular and flat, having two major surfaces 114, 115 and four side edges 116, 117, 118, 119. The analyte test strip 200 includes a sample receiving end 120 where a sample is applied to the test strip, as well as a meter connection end 121 where the analyte test strip 200 is electrically coupled to the test meter.

It should be appreciated that the analyte test strip shown is exemplary and that other types and shaped analyte test strips maybe used with the dispensers described in the present disclosure—e.g., FREESTYLE® and FREESTYLE LITE™ test strips sold by ABBOTT DIABETES CARE Inc. In addition to the embodiments specifically disclosed herein, the dispensers of the present disclosure can be configured to work with a wide variety of analyte sensors, e.g., those disclosed in U.S. patent application Ser. No. 11/461,725, filed Aug. 1, 2006; U.S. Patent Application Publication No. 2007/0095661; U.S. Patent Application Publication No. 2006/0091006; U.S. Patent Application Publication No. 2006/0025662; U.S. Patent Application Publication No. 2008/0267823; U.S. Patent Application Publication No. 2007/0108048; U.S. Patent Application Publication No. 2008/0102441; U.S. Patent Application Publication No. 2008/0066305; U.S. Patent Application Publication No. 2007/0199818; U.S. Patent Application Publication No. 2008/0148873; U.S. Patent Application Publication No. 2007/0068807; U.S. patent application Ser. No. 12/102,374, filed Apr. 14, 2008, and U.S. Patent Application Publication No. 2009/0095625; U.S. Pat. No. 6,616,819; U.S. Pat. No. 6,143,164; U.S. Pat. No. 6,592,745; U.S. Pat. No. 6,071,391 and U.S. Pat. No. 6,893,545; the disclosures of each of which are incorporated by reference herein. Analyte tests strips may be used to measure various analytes—e.g., glucose and/or ketones.

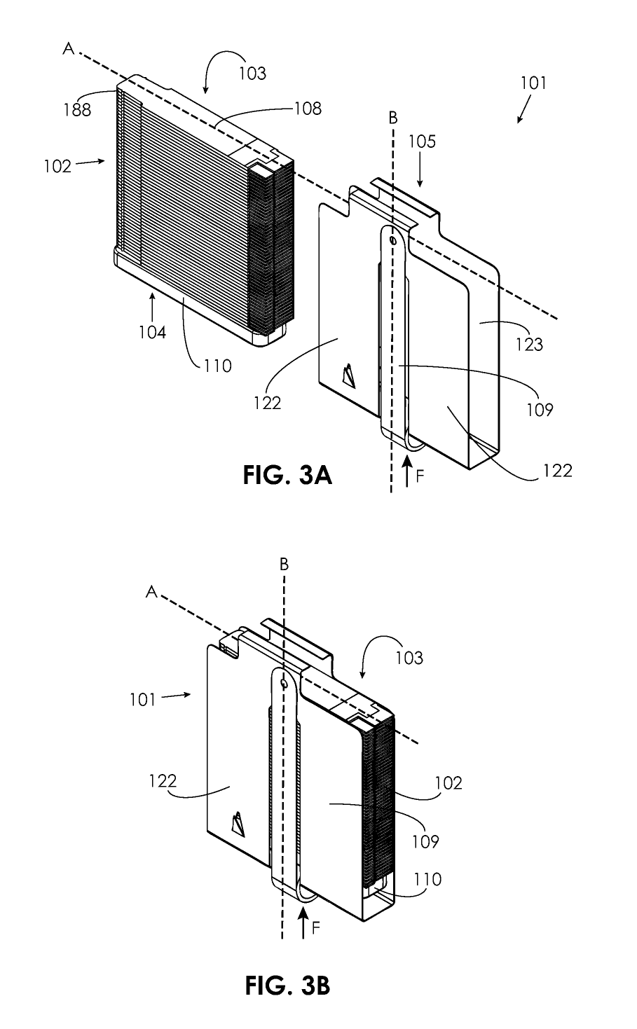

FIGS. 3A and 3B illustrate perspective views of the strip carrier and stack before and after the stack is disposed in the strip carrier, according to certain embodiments. FIG. 4 illustrates the strip carrier 101 of FIGS. 3A and 3B without the biasing element 109 coupled thereto, according to certain embodiments, and is described in conjunction with FIGS. 3A and 3B below.

As shown, the stack 102 of analyte test strips comprises a last analyte test strip 108 at the distal end 103 of the stack 102, and a next analyte test strip 188 adjacent to the last analyte test strip 108. A block of desiccant 110 is shown at a proximal end 104 of stack 102. The desiccant block 110 serves to absorb moisture and maintain a dry environment for the analyte test strips inside the dispenser 100. At the same time, the desiccant block 110 may serve as a base for the stack 102 of analyte test strips that are disposed thereon. In such case, the biasing element 109 may apply the biasing force to the stack 102 via the desiccant 110 block without having to contact an analyte test strip and possibly damage the test strip. The desiccant may be implemented in any variety of manners—e.g., as loose desiccant powder encased in a secondary container (e.g., a porous carrier made out of metal, metal alloy, polymers such as a hard plastic, etc.); extruded to form a solid block or film on a solid block; co-molded with a polymer to make a solid plastic block that has desiccating properties; etc.

Strip carrier 101 is shown coupled with biasing element 109. When the stack 102 is disposed within the strip carrier 101, biasing element 109 applies a biasing force F to the stack 102 of analyte test strips via the block of desiccant 110. The biasing force F is applied longitudinally to stack 102 to push the stack 102 towards the distal end 105 of the strip carrier 101 and towards the dispensing element 107 (not shown in FIGS. 3A and 3B). The biasing force F, for example, pushes the stack 102 against dispensing element 107 (not shown) such that the next analyte test strip 188 is positioned adjacent to the dispensing element 107 when the last analyte test strip 108 has been removed from the dispenser 100.

The strip carrier 101 shown includes two sidewalls 122, 123 that extend along the sides of the stack 102 when the stack 102 is disposed within the strip carrier 101. The sidewalls 122, 123 prevent movement by the stack 102 in directions toward the sidewalls 122, 123. Stack 102 is positioned in the strip carrier 101 with the last analyte test strip 108 positioned near the distal end 105 of the strip carrier 101. The distal end 105 of the strip carrier 101 is configured to provide an avenue for the last analyte test strip 108 to be displaced latitudinally from the distal end 103 of stack 102 and out of the strip carrier 101.

The strip carrier, 101, may be made from, for example, a generally rectangular shaped sheet of material may be bent widthwise along two parallel lines, shown as dotted lines P1 and P2 in FIG. 4, to form two extending sidewalls 122, 123 that are spaced apart at a width W slightly larger than the width of the stack 102 of analyte test strips. Furthermore, the surface 124 between the two bends may form a base surface which the stack 102 of analyte test strips (or block of desiccant 110) may be disposed on when in the strip carrier 101.

It should be understood that the embodiment shown is exemplary and that other shaped strip carriers may be suitable for holding the stack 102 of analyte test strips. As stated before, the strip carrier 101 may be made from any type of material that is sturdy enough to hold and maintain the stack 102 of analyte test strips. For example, the strip carrier 101 may be made from various metals and metal alloys (e.g., aluminum, aluminum alloys, etc.), polymers such as plastics, or any other suitable material. In some instances, a light weight material is used to account for weight consideration of the hand-held dispenser 100.

Biasing element 109 applies a biasing force F to the stack 102 of analyte test strips in the direction of the dispensing element 107 of the strip carrier 101. As stated before, any suitable biasing element 109 may be used to apply the biasing force F to the stack 102. In certain embodiments, a constant force spring may be implemented to provide an approximate constant force to the stack 102 irrespective of the number of analyte test strips remaining in the stack 102. In this way an uneven distribution of force (e.g., more force when a full stack 102 is present and less force as the stack 102 reduces in size, or vice versa) is mitigated.

In the embodiment shown in FIGS. 3A and 3B, a constant force spring is shown in the form of a rolled ribbon of spring steel or other metal or metal alloy. The spring is relaxed when it is fully rolled up. As it is unrolled, a restoring force (coming primarily from the portion of the spring near the roll) is generated and functions as the biasing force.

The biasing element 109 is coupled to the strip carrier 101 and extended (e.g., unrolled) along a sidewall 122 such that the second end of the biasing element 109 coils up towards the distal end 105 of the strip carrier 101, thus providing the biasing force F against the block of desiccant 110 and stack 102 towards the distal end 105 of the strip carrier 101. As shown in FIG. 4, strip carrier 101 shown includes an opening 125 in the base surface 124 and along a sidewall 122. The opening 125 enables the biasing element 109 to coil upwards towards the distal end 105 of the strip carrier 101 as analyte test strips are dispensed from the stack 102.

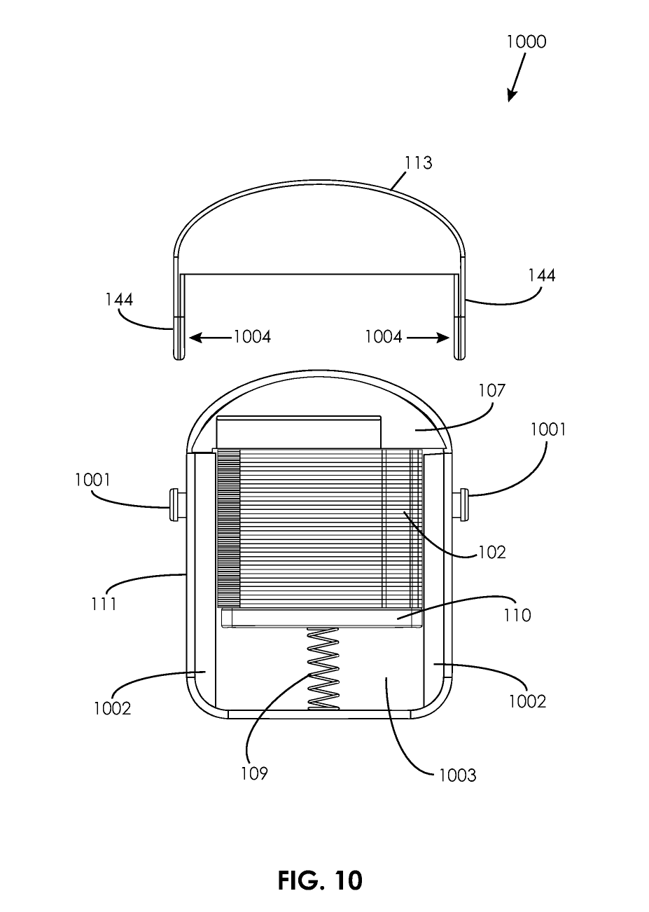

The biasing element 109 may be coupled to the strip carrier 101 in any variety of suitable manners—e.g., screwed, glued, fastened, hinged, etc. It should be understood that any type of biasing element 109 may be used to apply a biasing force to the stack 102 of analyte test strips in the direction of the dispensing section of the strip carrier 101. For example, in an alternative embodiment, a non-constant force spring may be used—e.g., positioned between the proximal surface of the strip carrier 101 and the stack 102 of analyte test strips to provide the biasing force (e.g., as described in FIG. 10).

As shown in FIG. 4, strip carrier 101 includes coupling elements 126 that serve to slidably couple the dispensing element 107 to the strip carrier 101. The coupling elements 126 is slidably coupled to the dispensing element 107 in a manner that allows the dispensing element 107 to slide latitudinally to the strip carrier 101 while remaining coupled. In the embodiment shown, coupling elements comprise rectangular-shaped arm extensions 127 that extend from the sidewalls 122, 123 and bend inwards at the end to form lips 128 along the edges of the arm extensions 127. A dispensing element 107 is shaped and sized to fit between the arm extensions 127 and mate with the arm extensions 127 and lips 128. As will be described later, the lips 128 slide within the grooves or slots as the dispensing element 107 is slid latitudinally relative to the strip carrier 101.

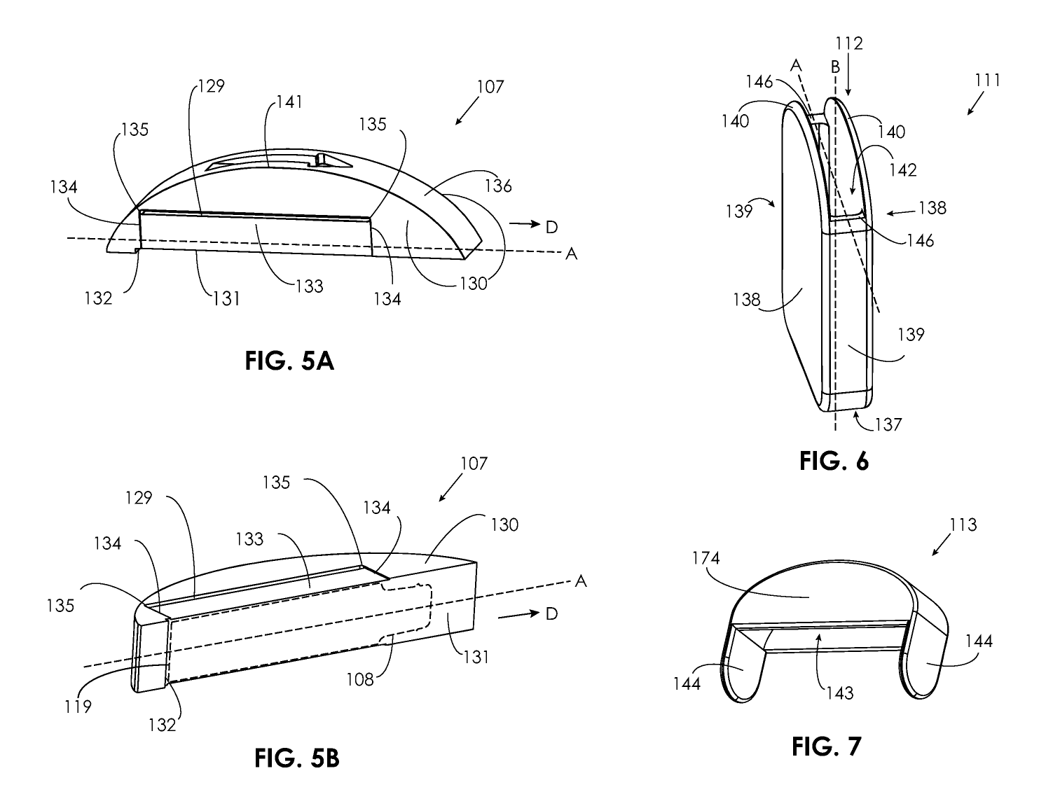

FIGS. 5A and 5B illustrate perspective views of a dispensing element, according to certain embodiments. Dispensing element 107 is shown comprising two sidewalls 130, an abutment surface 131, and distal surface 136. Dispensing element 107 is shaped and sized to couple to the strip carrier 101 and latitudinally slide relative to the strip carrier 101 such that the last analyte test strip 108 may be displaced and removed from the dispenser 100.

In the embodiment shown, the abutment surface 131 abuts a major surface 115 of the last analyte test strip 108 (the last analyte test strip 108 illustrated as a dotted line in FIG. 5B to facilitate explanation of the dispensing element 107). The dispensing element 107 further includes an engagement element 132 to engage the last analyte test strip 108 and displace the last analyte test strip 108 in a latitudinal direction when the dispensing element 107 is slid in the same latitudinal direction. In the embodiment shown, the engagement element 132 comprises a protrusion extending from the abutment surface 131, and extending adjacent to a side edge 119 of the last analyte test strip 108 when the last analyte test strip 108 is abutting the abutment surface 131. In this way, when the dispensing element 107 is moved in a direction D along latitudinal axis A, the engagement element 132 pushes into the side edge 119 of the last analyte test strip 108 and displaces the last analyte test strip 108 in direction D. When the dispensing element 107 is then moved in the opposite direction of arrow D, the engagement element 132 disengages the side edge 119 of the last analyte test strip 108 and returns towards its original starting position with the abutment surface 131 sliding against the last analyte test strip 108 without displacing the analyte test strip 108 back to its original starting position on stack 102.

The engagement element 132 is shaped and sized to be smaller than the height of the side edge of an analyte test strip to avoid engaging the next analyte test strip at the same time. In alternative embodiments, the engagement element 132 may be designed larger than the height of the side edge of an analyte test strip in order to dispense more than one analyte test strip at a time

In the embodiment shown in FIGS. 5A and 5B, the two sidewalls 130 of the dispensing element 107 extend from the abutment surface 131 and fit between the arm extensions 127 of the strip carrier 101. It should be appreciated that in alternative embodiments, the dispensing element 107 may be a different size width than the strip carrier 101 and still remain slidably coupled to the strip carrier 101.

In the embodiment shown, each sidewall 130 includes a recessed surface 133 and slot 129 that serve as mating elements for the coupling elements 126 of the strip carrier 101. The coupling elements 126 extend along the recessed surfaces 133 and fit within the slots 129 such that the coupling elements slide along the recessed surfaces 133 and within slots 129 when the dispensing element is slid in the latitudinal direction. For example, when the dispensing element 107 is coupled to the strip carrier 101, the arm extensions 127 on the strip carrier 101 are positioned on the recessed surface 133 of the dispensing element 107 with the lip 128 of the extension 127 inside of slot 129 on dispensing element 107. In this way, the arm extensions 127 may slide along the recessed surface 133 and the lip 128 may slide within the slot 129 when the dispensing element 107 is slid. Line A is illustrated to indicate the latitudinal axis in which the dispensing element 107 is moved when coupled to the strip carrier 101.

Stops may be provided to limit the distance that the dispensing element 107 may move latitudinally. For instance, the ends 134 of the recessed surfaces 133 as well as the ends 135 of the slots 129 function as stops that are encountered by the arm extensions and lips 128 when the dispensing element 107 is slid along the latitudinal axis. The lip 128 also functions to hold the dispensing element 107 in place as the biasing element 109 applies biasing force F to the stack 102 towards the dispensing element 107.

In the embodiment shown, the sidewalls 130 and distal surface 136 of the dispensing element 107 are shaped to have a curved contour 141. The curved contour 141 may be shaped, for example, to align flush with a curved contour of the housing 111 and a curved contour of a cavity within cap 113. In this way a tight seal may be established when the cap 113 is coupled to the housing 111.

Dispenser 100 also includes a housing 111 which serves to house the strip carrier 101, stack 102 of analyte test strips, and dispensing element 107. The housing 111 functions may protect the strip carrier 101, stack 102 of analyte test strips, and dispensing element 107 from physical damage and contaminants such as dirt, debris, water vapor and moisture, etc.

FIG. 6 illustrates a perspective view of a housing, according to certain embodiments. In the embodiment shown, housing 111 includes a rectangular base 137 with four sidewalls extending from each side of the base 137. The four sidewalls form a cavity 142. The strip carrier 101 and stack 102 are disposed in the cavity 142. The four sidewalls include two major sidewalls 138 extending from the longer sides of the base and two minor sidewalls 139 extending from the shorter sides of the base. The cavity 142 has an opening at approximately the same longitudinal height of the ends 146 of the two minor sidewalls 139.

When the strip carrier 101 is disposed within the housing 111, the two minor sidewalls extend approximately to the distal end of the stack 102. The two major sidewalls 138 extend farther than the two minor sidewalls 139 and extend approximately to the distal surface 136 at the distal end of the dispensing element 107. The ends of the major sidewalls 138 include a curved contour 140 that are shaped similar to the curved contour 141 of the distal end of the dispensing element 107 such that the two curved contours 140 and 141 are approximately flush. In the embodiment shown, the curved contours 140 and 141 are semi-elliptically shaped and align approximately flush with one another. It should be appreciated that in other embodiments, the curved contours 104 and 141 may be another curved shape (e.g., semi-circularly shaped).

In the embodiment shown, the open end 112 of housing 111 includes the distal ends of the major sidewalls 138 that extend beyond the minor sidewalls 139, as well as the ends 146 of the minor sidewalls 139. The open end 112 also includes the opening of cavity 142. When the strip carrier 101 and stack 102 are disposed within housing 111, the last analyte test strip 108 is positioned slightly past the ends 146 of minor sidewalls 139 and slightly outside cavity 142 such that the last analyte test strip 108 may be displaced latitudinally across one of the ends 146 and partially outside the housing 111. The dispensing element 107 is disposed within the housing 111 longitudinally above the ends 146 of minor sidewalls 139 and slightly outside opening of cavity 142 such that the dispensing element 107 may slide latitudinally without being obstructed by the ends 146 of the minor sidewalls 139.

As stated before, it should be appreciated that in some alternative embodiments, the housing 111 may be comprised of more than one piece and may be comprised of more than one type of material. Further, it should be appreciated that the strip carrier 101, stack 102, and dispensing element 107 may be disposed within the housing 111 in any variety of manners—e.g., inserted into the opening of cavity 142 of the housing 111; the housing 111 assembled around the strip carrier 101, etc.

Moreover, the housing 111 may be made from any variety of materials (e.g., hard molded plastic, elastomeric material, metal and/or metal alloys, etc.) that provide protection to the strip carrier 101, stack 102, and dispensing element 107 from physical damage. The housing 111 may also provide protection from contamination, such as dirt, oil, debris, water vapor and moisture, etc. In some instance, the housing 111 is made from a material that acts as a strong barrier to water vapor and moisture—e.g., cycloolefin copolymer, etc.

In some aspects of the present disclosure, an elastomeric cap is provided that may be coupled with the dispensers of the present disclosure. FIG. 7 illustrates a cap for sealing dispenser, according to certain embodiments. The cap 113 is shown including an elastomeric shell 174 having formed therein a cavity 143 that receives the open end 112 of the housing 111. Cap 113 also includes side arms 144 that extend from the elastomeric shell to provide protection near the ends 146 of the minor sidewalls 139 of housing 111 where analyte test strips may be more exposed. The side arms 144 may be elastomeric, and in some instances, are made of the same material as the elastomeric shell 174.

In certain embodiments, the cap 113 is made out of a thermoplastic elastomer, a thermoset material, EPDM, or any other elastomeric material to seal the dispenser against the ingress of contaminants such as dirt, debris, oil, moisture and water vapor, etc. In some instances, the cap 113 may be made of a material that exhibits strong barrier properties to water vapor and moisture.

In some embodiments, the elastomeric cap 113 may be undersized in relation to the open end 112 of the housing 111 such the elastomeric cap 113 may be stretched over the open end 112 of the housing 111 to provide a pressure-fit seal around the open end 112 of the housing 111. The elastomeric cap may be undersized to varying degrees. The more undersized the cap 113 is, the more force required by the user to stretch the elastomeric cap 113 to fit around the open end 112 of housing 111. The elastomeric cap should be undersized enough to provide a pressure-fit seal but not too undersized to make it difficult for the user to put on the dispenser 100. In some instances, the elastomeric cap is slightly undersized in relation to the size of the open end 112 of housing 111. If the cap 113 is made from a mater that has strong barrier properties to water vapor and moisture, then the elastomeric cap 113 provides a pressure-fit seal along with strong barrier properties to water vapor and moisture. The cap may be removed when an analyte test strip is needed, and then recoupled with the dispenser after a test strip is dispensed.

In some aspects, the cap 113 is shaped and sized to correspond to the open end 112 of the housing 111 that fits within cavity 143. In the embodiment shown in FIG. 7, the cavity 143 includes an opening and a curved interior. The opening of cavity 143, for example, is rectangular and similarly shaped to the rectangular housing formed by the four sidewalls 138, 139 and thus provides a tight seal when stretched around the housing 111. Furthermore, the interior surface of the cavity has a curved contour that is similarly shaped to the curved contour 141 of the dispensing element 107 and the curved contour 140 of the housing 111 to provide a tight seal when stretched around the curved contours of the dispensing element 107 and housing 111.

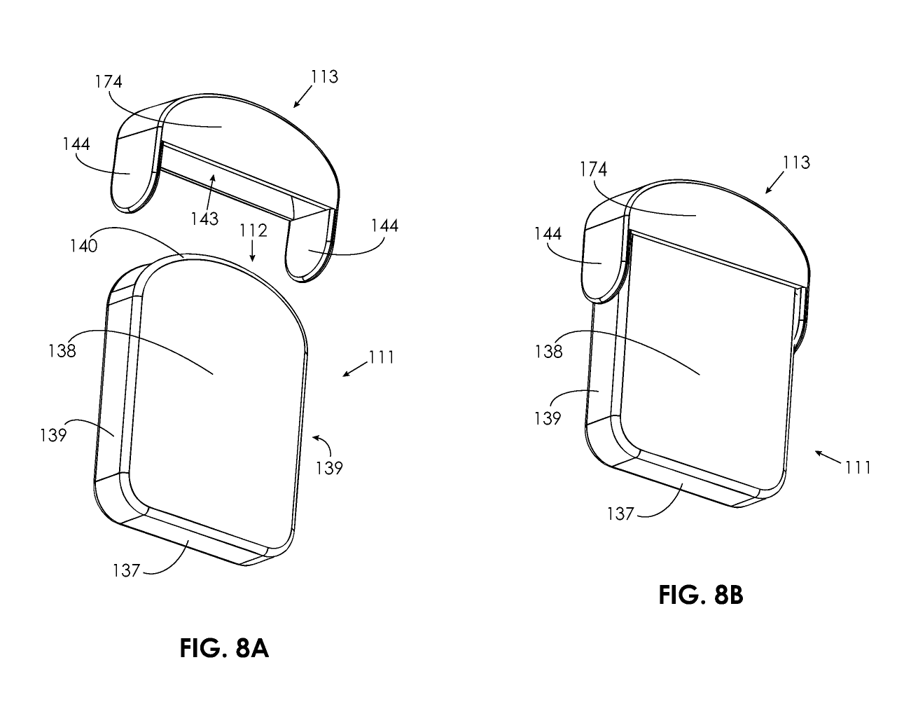

FIGS. 8A and 8B illustrate a cap 113 uncoupled and coupled, respectively, with dispenser 100, according to certain embodiments. Cap 113 includes cavity 143 which receives the dispenser 100. When coupled, the cap 113 provides protection to the open end 112 of the housing 111 by covering the dispensing element 107 and ends of the major sidewalls 138 of the housing 111. In the embodiment shown, the curved contour 140 of the housing 111 is approximately flush with the curved contour 141 of the dispensing element 107. The elastomeric cap 113 is slightly undersized and stretched around the dispensing element 107 and housing 111 to provide a pressure-fit seal.

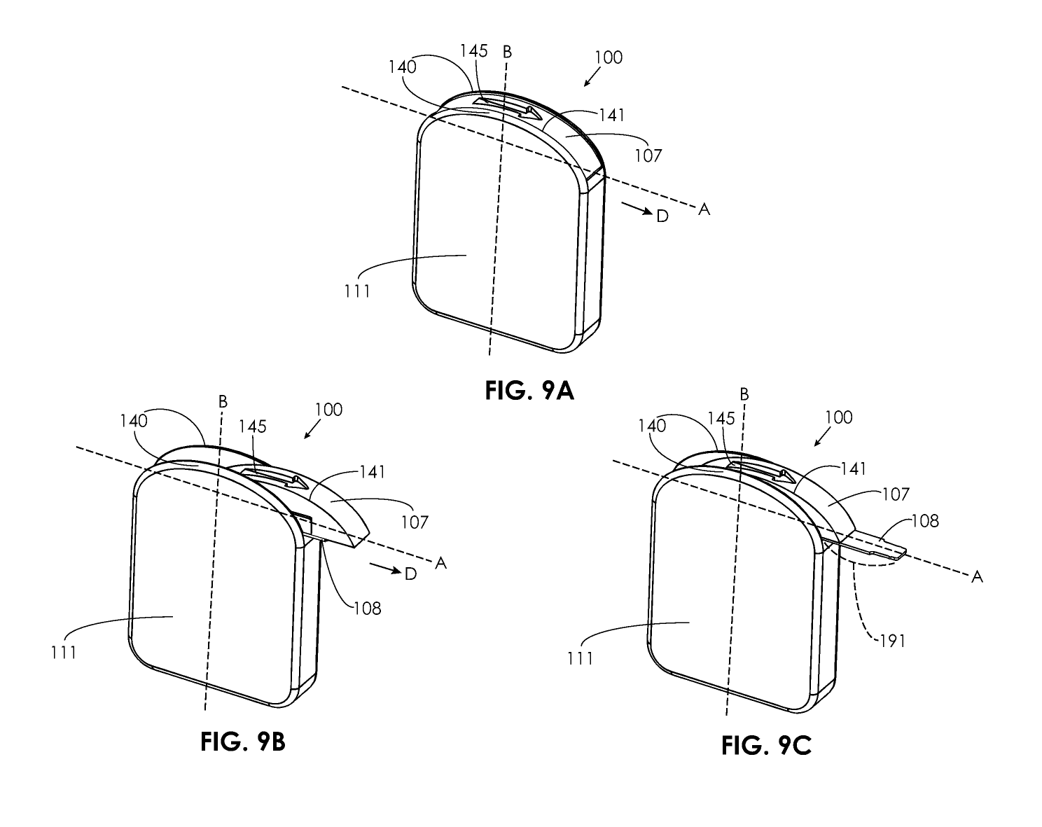

In use, when a user (e.g., a diabetic patient) needs an analyte test strip, the user removes cap 113 from dispenser 100 and slides the dispensing element 107 latitudinally to displace an analyte test strip at least partially outside the dispenser 100. FIGS. 9A, 9B, and 9C illustrate the dispenser at various stages when an analyte test strip is being dispensed, according to certain embodiments. In FIG. 9A, the dispenser 100 is shown after cap 113 is removed and prior to the dispensing element being slid. The dispensing element 107 is shown in a starting position with the curved contour 141 aligning approximately flush with the curved contour 140 of housing 111. As previously described, the biasing element 109 applies force to the stack 102 of analyte test strips in the strip carrier 101 which presses the stack 102 against the abutment surface 131 of the dispensing element 107 with the engagement element 132 extending along a side edge 119 of an analyte test strip.

When a user of the dispenser 100 wants to remove an analyte test strip, the user applies force to the dispensing element 107 to slide the dispensing element 107 in direction D along latitudinal axis A, as shown in FIG. 9B. In some instances, such as in the embodiment shown, the dispensing element 107 includes an indicator 145 that indicates to the user the direction to slide the dispensing element 107 to dispense an analyte test strip.

As previously described, the dispensing element 107 is slid in the latitudinal direction D until coupling elements 126 on the strip carrier 101 come in contact with stops on dispensing element 107, thus preventing the dispensing element 107 from being slid any further. For example, arm extensions 127 on strip carrier 101 may be positioned on a recessed surface 133 of the dispensing element 107 with a lip 128 of the arm extension 127 inside of a slot 129 on the dispensing element 107 such that the arm extension 127 slides along the recessed surface 133 and the lip 128 slides within slot 129 when the dispensing element is slid. When arm extensions 127 and/or lips 128 come in contact with stops 134 and/or stops 135 on dispensing element 107, the dispensing element 107 is prevent from being slid any further.

As the dispensing element 107 is slid latitudinally in direction D, an engagement element 132 engages the side edge 119 of last analyte test strip 108 and applies a force to the last analyte test strip 108 to displace the last analyte test strip in direction D, as shown in FIG. 9B. The last analyte test strip 108 in the stack 102 is abutting the abutment surface 131 of the dispensing element 107 and slides along with the dispensing element 107 as the user slides the dispensing element 107. As the dispensing element 107 is slid in direction D, the analyte test strip 108 is slid in direction D along the end surface 146 of one of the minor sidewalls 139 of the housing 111.

After the dispensing element 107 is slid in the latitudinal direction D, the dispensing element 107 may be slid in the opposite direction (e.g., in the direction opposite of arrow D), as shown in FIG. 9C. As the dispensing element 107 is slid in the opposite direction, the engagement element 132 is disengaged from the side edge 119 of the last analyte test strip 108 and does not apply any force to the last analyte test strip 108 that displaces the last analyte test strip 108. As the dispensing element is slid in the opposite direction of arrow D back to its starting position, the abutment surface 131 of the dispensing element 107 slides along the major surface of the last analyte test strip 108, maintain the last analyte test strip 108 in its displaced position. The last analyte test strip 108 does not return back to its starting position on stack 102 when the dispensing element 107 returns to its starting position. As shown in FIG. 9C, the last analyte test strip 108 remains displaced partially outside the housing 111 as the dispensing element 107 is slid back to its starting position. Portion 191 of last analyte test strip 108 remains exposed and permits a user to grab the analyte test strip 108 and remove it completely from dispenser 100. In an alternative embodiment, when the dispensing element 107 is slid in the displacement direction, the analyte test strip is displaced completely past the sidewall of the housing 111 and ejected from the dispenser 100.

As stated above, when the dispensing element 107 is returned to its starting position aligned approximately flush with the housing 111 of dispenser 100, the last analyte test strip 108 remains exposed in a displaced position for the user to grab. The last analyte test strip 108, although displaced, still remains at least partially within housing 111 between the dispensing element 107 and the next analyte test strip 188. As the last analyte test strip 108 is removed from the dispenser 100 by the user, the next analyte test strip 188 that was adjacent to the last analyte test strip 108, is pressed flush against the abutment surface 131 via the biasing force F applied by the biasing element 109 to the stack 102 of analyte test strips via desiccant block 110. The engagement element 132 then extends along a side edge 119 of the next analyte test strip 188, enabling the dispensing element 107 to be able to displace the next analyte test strip 188 when the dispensing element 107 is again slid in the latitudinal direction D.

It should be appreciated that if the analyte test strip is removed by the user before the dispensing element 107 is completely back to its starting position, the next analyte test strip may be pressed against the abutment surface 131 and against the engagement element, instead of having the engagement element 132 extending along the side edge 119 of the next analyte test strip 188. In such case, when the dispensing element 107 is returned all the way back to its starting position flush with the housing 111, the engagement element 132 will slide along the major surface of the next analyte test strip 188 until it passes the side edge 119 of the next analyte test strip 188, at which point the next analyte test strip 188 will flushly abut the abutment surface 131 with the engagement element 132 extending along the side edge 199 of the next analyte test strip 188. The process may then be repeated for the next analyte test strip 188 and remaining analyte test strips within stack 102, until all analyte test strips are dispensed from dispenser 100. The user may then, for example, dispose of dispenser 100.

It should be appreciated that the dispensers shown in figures described above are exemplary, and that other dispensers may be implemented. For example, FIG. 10 illustrates cross-sectional side view of an analyte test strip dispenser, according to certain embodiments. For the sake of brevity, some duplicative description of various components of the dispenser will not be described again. As shown in FIG. 10, dispenser 1000 comprises a stack 102 of analyte test strips, dispensing element 107, housing 111, and cap 113. The stack 102 of analyte test strips is disposed on a block of desiccant 110. A biasing element 109 is coupled to the block of desiccant 110 and applies a biasing force F against the block of desiccant 110 to push the stack 102 against the dispensing element 107. In the embodiment shown in FIG. 10, the stack 102 is disposed within housing 111 and maintained in the stacked position by the housing 111, as opposed to the strip carrier 101 described in previous embodiments. For example, housing 111 may include alignment walls 1002 that help maintain the stack 102 in alignment as the biasing element 109 pushes stack towards the dispensing element 107. In the embodiment shown, biasing element 109 is a spring that applies a biasing force 109 to desiccant block 110.

Dispensing element 107 is slidably coupled to housing 111 and configured to latitudinally displace the last analyte test strip 108 at least partially outside housing 111, and to maintain the last analyte test strip in the displaced position when slid back in the opposite latitudinal direction.

Dispenser 1000 also includes retention elements 1001 to retain the cap 1113 on the housing 111. Cap 1113 is shown including mating elements 1004 on side arms 144. Mating elements couple with the retention elements to retain the cap 1113 on the housing. For example, as shown, retention elements 1001 may be knobs and mating elements may be indents or recessing in the cap 1113 that may be stretched over knobs 1001 to fasten the cap 113 to housing 111.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and aspects of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary aspects shown and described herein. Rather, the scope and spirit of present invention is embodied by the appended claims.

That which is claimed is:

1. A analyte test strip dispenser, comprising:
a housing including an open end of the housing;
a stack of analyte test strips disposed within the housing, the stack of analyte test strips stacked in a longitudinal direction and comprising a first analyte test strip at a first end of the stack and a second analyte test strip adjacent the first analyte test strip, the first end of the stack near the opening of the housing;
a dispensing element coupled to the housing and configured to displace the first analyte test strip out of the opening of the housing;
a biasing element coupled to the strip carrier and applying a biasing force to the stack of analyte test strips in a direction towards the dispensing element; and
an elastomeric cap including a cavity that receives the open end of the housing, wherein the elastomeric cap is undersized in relation to the open end of the housing such the elastomeric cap stretches over the open end of the housing and provides a pressure-fit seal around the open end of the housing.

2. The analyte test strip dispenser of claim 1, wherein the elastomeric cap comprises a material having strong barrier properties for water vapor and moisture.

3. The analyte test strip dispenser of claim 2, wherein the material is a thermoplastic elastomer, a thermoset polymer, or ethylene propylene diene Monomer (EPDM).

4. The analyte test strip dispenser of claim 3, wherein the material is cycloolefin copolymer.

5. The analyte test strip dispenser of claim 2, wherein the dispensing element comprises a first curved contour and the open end of the housing includes a second curved contour, the first curved contour similarly shaped to the second curved contour, and wherein the cap comprises an interior surface of the cavity having a third curved contour that approximates a shape of the first and second curved contours.

6. The analyte test strip dispenser of claim 2, wherein the dispensing element comprises a first curved contour that is received by the cavity of the cap, the first curved contour similarly shaped to a second curved contour of the open end of the housing received by the cavity of the cap, wherein the cap comprises an interior surface of the cavity having a third curved contour that approximates a shape of the first and second curved contours.

7. The analyte test strip dispenser of claim 6, wherein the first, second, and third curved contours have are approximately semi-elliptically shaped.

8. The analyte test strip dispenser of claim 6, wherein the first, second, and third curved contours have are approximately semi-circularly shaped.

9. The analyte test strip dispenser of claim 1, wherein the cavity of the elastomeric cap includes an opening that is similarly shaped to the open end of the housing 111 so as to provide a tight seal.

10. The analyte test strip dispenser of claim 2, further comprising:
a block of desiccant coupled to the stack of analyte test strips and disposed within the housing to absorb water vapor and moisture, the block of desiccant at a second end of the stack of analyte test strips, the second end of the stack opposite the first end of the stack;
wherein the biasing element is coupled to the block of desiccant such that the biasing element applies the biasing force to the stack of analyte test strips via the block of desiccant.

11. The analyte test strip dispenser of claim 1, wherein the elastomeric cap comprises elastomeric side arms that removably couple to the dispenser when the cap is coupled with the dispenser.

12. The analyte test strip dispenser of claim 1, comprising:
a strip carrier within the housing, the strip carrier having the stack of analyte test strips disposed in the strip carrier, the dispensing element slidably coupled to the strip carrier and adjacent to the first analyte test strip, wherein the dispensing element is coupled to the housing via the strip carrier;
wherein the dispensing element configured to latitudinally displace the first analyte test strip from a first position to a second position when the dispensing element is slid in a first latitudinal direction, and wherein the first analyte test strip remains in the second position when the dispensing element is slid back in a second latitudinal direction that is opposite the first latitudinal direction.

13. The analyte test strip dispenser of claim 12, wherein the dispensing element includes an abutment surface that abuts the first analyte test strip and an engagement element that engages the first analyte test strip and displaces the first analyte test strip in the first latitudinal direction when the dispensing element is slid in the first latitudinal direction.

14. The analyte test strip dispenser of claim 13, wherein the engagement element comprises a protrusion extending from the abutment surface and adjacent to a first side edge of the first analyte test strip, wherein the protrusion pushes the first analyte test strip from the first position to the second position when the dispensing element is slid in the first latitudinal direction.

15. The analyte test strip dispenser of claim 14, wherein when the first analyte test strip is removed from the analyte test strip dispenser, the biasing force displaces the second analyte test strip towards the dispensing element such that the abutment surface is abutting the second analyte test strip with the protrusion extending adjacent to a second side edge of the second analyte test strip.

16. The analyte test strip dispenser of claim 13, wherein the engagement element engages the second analyte test strip when the first analyte test strip is removed from the analyte test strip dispenser.

17. The analyte test strip dispenser of claim 12, wherein the dispensing element comprises a first curved contour that aligns approximately flush with a second curved contour of the housing prior to the dispensing element being slid in a first longitudinal direction.

18. The analyte test strip dispenser of claim 12, wherein the dispensing element comprises recessed surfaces and slots for coupling with the strip carrier, and wherein the strip carrier comprises coupling elements that extend along the recessed surfaces and fit within the slots, the coupling elements sliding along the recessed surfaces and within the slots when the dispensing element is slid in the first latitudinal direction and the second latitudinal direction.

19. An elastomeric cap for sealing an analyte test strip dispenser, comprising:
an elastomeric shell forming a cavity that receives an open end of an analyte test strip dispenser; and
an interior surface within the cavity;
wherein the elastomeric cap is elastic so as to be stretchable over the open end of the dispenser to provide a pressure-fit seal around the open end of the dispenser, and wherein the elastomeric cap comprises a material having strong barrier properties for water vapor and moisture.

20. The elastomeric cap of claim 19, wherein the material comprises a thermoplastic elastomer, a thermoset polymer, or ethylene propylene diene Monomer (EPDM).

21. The elastomeric cap of claim 20, wherein the material comprises a cycloolefin copolymer.

22. The elastomeric cap of claim 19, wherein the interior of the cavity has a curved contour that approximates a shape of a curved contour of the dispenser.

23. The elastomeric cap of claim 19, comprising:
elastomeric side arms that extend from the elastomeric shell and removably couple to the dispenser when the cap is coupled with the dispenser.
